(19) United States
(12) Patent Application Publication
(10) Pub. No.: US 2025/0149969 A1
(43) Pub. Date: May 8, 2025

(54) ELECTRONIC DEVICE HAVING PLURALITY OF CONVERTERS AND METHOD FOR MANUFACTURING SAME

(71) Applicant: SAMSUNG ELECTRONICS CO., LTD., Suwon-si (KR)

(72) Inventors: Keonwoo KIM, Suwon-si (KR); Moonyoung KIM, Suwon-si (KR); Jeongil KANG, Suwon-si (KR)

(73) Assignee: SAMSUNG ELECTRONICS CO., LTD., Suwon-si (KR)

(21) Appl. No.: 19/011,898

(22) Filed: Jan. 7, 2025

Related U.S. Application Data
(63) Continuation of application No. PCT/KR2023/010016, filed on Jul. 13, 2023.

(30) Foreign Application Priority Data
Aug. 29, 2022 (KR) 10-2022-0108610

(51) Int. Cl. H02M 1/00; H02M 3/00; H02M 3/335

(52) U.S. Cl. CPC H02M 1/0077; H02M 3/003; H02M 3/33569

(57) ABSTRACT

An electronic device and a method of forming the electronic device is disclosed. The electronic device includes a first converter including a first transformer and a second transformer of which a primary winding is connected in parallel with a primary winding of the first transformer; and a second converter of which a primary input is connected in parallel with the first converter, and which includes a third transformer and a fourth transformer of which a primary winding is connected in parallel with a primary winding of the third transformer, wherein a secondary winding included in the first converter may be connected in series with a secondary winding included in the second converter.

### CROSS-REFERENCE TO RELATED APPLICATIONS

This application is a continuation of International Application No. PCT/KR2023/010016, filed Jul. 13, 2023, and claims foreign priority to Korean Application No. 10-2022-0108610, filed Aug. 29, 2022, the disclosures of which are incorporated herein by reference in their entireties.

### TECHNICAL FIELD

The disclosure relates to an electronic device and a method for manufacturing the same, and more particularly, to an electronic device that includes a plurality of converters, and a method for manufacturing the same.

### BACKGROUND ART

Spurred by the development of electronic technologies, various types of electronic devices are being developed. In particular, recently, electronic devices including module-type DC-DC converters are being distributed.

A module-type DC-DC converter is used in a manner of connecting module-type converters having small capacity in parallel according to the size of a load. Here, it is necessary that current balancing among the module-type converters connected in parallel is maintained.

### DISCLOSURE

### Technical Solution

According to an embodiment of the disclosure for achieving the aforementioned purpose, an electronic device includes a first converter including a first transformer and a second transformer of which a primary winding is connected in parallel with a primary winding of the first transformer, and a second converter of which a primary input end is connected in parallel with the first converter, and which includes a third transformer and a fourth transformer of which a primary winding is connected in parallel with a primary winding of the third transformer, wherein a secondary winding included in the first converter may be connected in series with a secondary winding included in the second converter.

Also, a secondary winding of the first transformer may be connected in series with a secondary winding of one of the third transformer or the fourth transformer, and a secondary winding of the second transformer may be connected in series with a secondary winding of the other one of the third transformer or the fourth transformer.

In addition, the first converter may further include a first switch controlled by a first gate signal, and a second switch controlled by a second gate signal, and the second converter may further include a third switch controlled by the first gate signal, and a fourth switch controlled by the second gate signal.

Also, the electronic device may further include control circuitry configured to, based on the second converter not being detected, provide an output voltage from one end of a secondary winding of the first transformer and one end of a secondary winding of the second transformer, and based on the second converter being detected, provide an output voltage from one end of a secondary winding of the third transformer and one end of a secondary winding of the fourth transformer.

In addition, the electronic device may further include a third converter of which a primary input end is connected in parallel with the first converter and the second converter, and which includes a fifth transformer and a sixth transformer of which a primary winding is connected in parallel with a primary winding of the fifth transformer, wherein a secondary winding of the first transformer may be connected in series with a secondary winding of the third transformer, a secondary winding of the second transformer may be connected in series with a secondary winding of the sixth transformer, and a secondary winding of the fourth transformer may be connected in series with a secondary winding of the fifth transformer.

Also, the electronic device may further include a first diode of which an anode is grounded, a second diode of which an anode is grounded, a third diode of which an anode is grounded, a fourth diode of which an anode is grounded, and an output capacitor of which one end is grounded. Further, a secondary winding of the first transformer may include a secondary first winding of the first transformer of which one end is connected to a cathode of the first diode and a secondary second winding of the first transformer of which one end is connected to a cathode of the second diode, and a secondary winding of the second transformer may include a secondary first winding of the second transformer of which one end is connected to a cathode of the third diode and a secondary second winding of the second transformer of which one end is connected to a cathode of the fourth diode, and a secondary winding of the third transformer may include a secondary first winding of the third transformer of which one end is connected to the other end of the secondary first winding of the first transformer and of which other end is connected to the other end of the output capacitor, and a secondary second winding of the third transformer of which one end is connected to the other end of the secondary second winding of the first transformer and of which other end is connected to the other end of the output capacitor, and a secondary winding of the fourth transformer may include a secondary first winding of the fourth transformer of which one end is connected to the other end of the secondary first winding of the second transformer and of which other end is connected to the other end of the output capacitor, and a secondary second winding of the fourth transformer of which one end is connected to the other end of the secondary second winding of the second transformer and of which other end is connected to the other end of the output capacitor.

In addition, the electronic device may further include an output capacitor of which one end is grounded, a first diode of which a cathode is connected to the other end of the output capacitor, a second diode of which a cathode is connected to an anode of the first diode, and of which an anode is grounded, a third diode of which a cathode is connected to the other end of the output capacitor, a fourth diode of which a cathode is connected to an anode of the third diode, and of which an anode is grounded, a fifth diode of which a cathode is connected to the other end of the output capacitor, a sixth diode of which a cathode is connected to an anode of the fifth diode, and of which an anode is grounded, a seventh diode of which a cathode is connected to the other end of the output capacitor, and an eighth diode of which a cathode is connected to an anode of the seventh diode, and of which an anode is grounded, wherein one end of a secondary winding of the first transformer may be connected to the anode of the first diode, one end of a secondary winding of the second transformer may be connected to the anode of the fifth diode, one end of a secondary winding of the third transformer may be connected to the other end of the secondary winding of the first transformer, and the other end may be connected to the anode of the third diode, and one end of a secondary winding of the fourth transformer may be connected to the other end of the secondary winding of the second transformer, and the other end may be connected to the anode of the seventh diode.

Also, the electronic device may further include an output capacitor of which one end is grounded, a first diode of which a cathode is connected to the other end of the output capacitor, a second diode of which a cathode is connected to an anode of the first diode, and of which an anode is grounded, a first capacitor of which one end is connected to the other end of the output capacitor, a second capacitor of which one end is connected to the other end of the first capacitor, and of which other end is grounded, a third diode of which a cathode is connected to the other end of the output capacitor, a fourth diode of which a cathode is connected to an anode of the third diode, and of which an anode is grounded, a third capacitor of which one end is connected to the other end of the output capacitor, and a fourth capacitor of which one end is connected to the other end of the third capacitor, and of which other end is grounded, wherein one end of a secondary winding of the first transformer may be connected to the anode of the first diode, one end of a secondary winding of the second transformer may be connected to the anode of the third diode, one end of a secondary winding of the third transformer may be connected to the other end of the secondary winding of the first transformer, and the other end may be connected to the other end of the first capacitor, and one end of a secondary winding of the fourth transformer may be connected to the other end of the secondary winding of the second transformer, and the other end may be connected to the other end of the third capacitor.

Further, the first converter and the second converter may be implemented on a printed circuit board (PCB).

Also, the first converter and the second converter may be implemented as module types that are detachable from the electronic device.

In addition, the first converter and the second converter may have a same structure, and have a same capacity.

Meanwhile, according to an embodiment of the disclosure, a method for manufacturing an electronic device includes the steps of forming a first converter including a first transformer and a second transformer of which a primary winding is connected in parallel with a primary winding of the first transformer, and forming a second converter of which a primary input end is connected in parallel with the first converter, and which includes a third transformer and a fourth transformer of which a primary winding is connected in parallel with a primary winding of the third transformer, wherein a secondary winding included in the first converter may be connected in series with a secondary winding included in the second converter.

Also, a secondary winding of the first transformer may be connected in series with a secondary winding of one of the third transformer or the fourth transformer, and a secondary winding of the second transformer may be connected in series with a secondary winding of the other one of the third transformer or the fourth transformer.

In addition, the step of forming the first converter may further include the steps of forming a first switch controlled by a first gate signal, and forming a second switch controlled by a second gate signal, and the step of forming the second converter may further include the steps of forming a third switch controlled by the first gate signal, and forming a fourth switch controlled by the second gate signal.

Also, the manufacturing method may further include the step of forming communication circuitry configured to, based on the second converter not being detected, provide an output voltage from one end of a secondary winding of the first transformer and one end of a secondary winding of the second transformer, and based on the second converter being detected, provide an output voltage from one end of a secondary winding of the third transformer and one end of a secondary winding of the fourth transformer.

In addition, the manufacturing method may further include the step of forming a third converter of which primary input end is connected in parallel with the first converter and the second converter, and which includes a fifth transformer and a sixth transformer of which primary winding is connected in parallel with a primary winding of the fifth transformer, wherein a secondary winding of the first transformer may be connected in series with a secondary winding of the third transformer, a secondary winding of the second transformer may be connected in series with a secondary winding of the sixth transformer, and a secondary winding of the fourth transformer may be connected in series with a secondary winding of the fifth transformer.

Also, the manufacturing method may further include the steps of forming a first diode of which anode is grounded, forming a second diode of which anode is grounded, forming a third diode of which anode is grounded, forming a fourth diode of which anode is grounded, and forming an output capacitor of which one end is grounded, wherein a secondary winding of the first transformer may include a secondary first winding of the first transformer of which one end is connected to a cathode of the first diode and a secondary second winding of the first transformer of which one end is connected to a cathode of the second diode, and a secondary winding of the second transformer may include a secondary first winding of the second transformer of which one end is connected to a cathode of the third diode and a secondary second winding of the second transformer of which one end is connected to a cathode of the fourth diode, and a secondary winding of the third transformer may include a secondary first winding of the third transformer of which one end is connected to the other end of the secondary first winding of the first transformer and of which other end is connected to the other end of the output capacitor, and a secondary second winding of the third transformer of which one end is connected to the other end of the secondary second winding of the first transformer and of which other end is connected to the other end of the output capacitor, and a secondary winding of the fourth transformer may include a secondary first winding of the fourth transformer of which one end is connected to the other end of the secondary first winding of the second transformer and of which other end is connected to the other end of the output capacitor, and a secondary second winding of the fourth transformer of which one end is connected to the other end of the secondary second winding of the second transformer and of which other end is connected to the other end of the output capacitor.

In addition, the manufacturing method may further include the steps of forming an output capacitor of which one end is grounded, forming a first diode of which cathode is connected to the other end of the output capacitor, forming a second diode of which cathode is connected to an anode of the first diode, and of which anode is grounded, forming a third diode of which cathode is connected to the other end of the output capacitor, forming a fourth diode of which cathode is connected to an anode of the third diode, and of which anode is grounded, forming a fifth diode of which cathode is connected to the other end of the output capacitor, forming a sixth diode of which cathode is connected to an anode of the fifth diode, and of which anode is grounded, forming a seventh diode of which cathode is connected to the other end of the output capacitor, and forming an eighth diode of which cathode is connected to an anode of the seventh diode, and of which anode is grounded, wherein one end of a secondary winding of the first transformer may be connected to the anode of the first diode, one end of a secondary winding of the second transformer may be connected to the anode of the fifth diode, one end of a secondary winding of the third transformer may be connected to the other end of the secondary winding of the first transformer, and the other end may be connected to the anode of the third diode, and one end of a secondary winding of the fourth transformer may be connected to the other end of the secondary winding of the second transformer, and the other end may be connected to the anode of the seventh diode.

Also, the manufacturing method may further include the steps of forming an output capacitor of which one end is grounded, forming a first diode of which cathode is connected to the other end of the output capacitor, forming a second diode of which cathode is connected to an anode of the first diode, and of which anode is grounded, forming a first capacitor of which one end is connected to the other end of the output capacitor, forming a second capacitor of which one end is connected to the other end of the first capacitor, and of which other end is grounded, forming a third diode of which cathode is connected to the other end of the output capacitor, forming a fourth diode of which cathode is connected to an anode of the third diode, and of which anode is grounded, forming a third capacitor of which one end is connected to the other end of the output capacitor, and forming a fourth capacitor of which one end is connected to the other end of the third capacitor, and of which other end is grounded, wherein one end of a secondary winding of the first transformer may be connected to the anode of the first diode, one end of a secondary winding of the second transformer may be connected to the anode of the third diode, one end of a secondary winding of the third transformer may be connected to the other end of the secondary winding of the first transformer, and the other end may be connected to the other end of the first capacitor, and one end of a secondary winding of the fourth transformer may be connected to the other end of the secondary winding of the second transformer, and the other end may be connected to the other end of the third capacitor.

In addition, the first converter and the second converter may be implemented on a printed circuit board (PCB).

Also, the first converter and the second converter may be implemented as module types that can be detached from the electronic device.

Further, the first converter and the second converter may have the same structure, and have the same capacity.

### DESCRIPTION OF DRAWINGS

FIG. 1A and FIG. 1B are diagrams for illustrating an example of using a plurality of converters;

FIG. 2 is a block diagram illustrating a configuration of an electronic device according to an embodiment of the disclosure;

FIG. 3 is a block diagram illustrating a detailed configuration of an electronic device according to an embodiment of the disclosure;

FIG. 4 is a diagram for illustrating a circuitry configuration of an electronic device according to an embodiment of the disclosure;

FIG. 5 is a diagram for illustrating a simulation result according to an embodiment of the disclosure;

FIG. 6 is a diagram for illustrating a case wherein a plurality of converters are implemented on a PCB according to an embodiment of the disclosure;

FIG. 7 is a diagram for illustrating a case wherein each of a plurality of converters is implemented as a module type according to an embodiment of the disclosure;

FIG. 8 and FIG. 9 are diagrams for illustrating a case wherein a converter is added to an electronic device 100 according to an embodiment of the disclosure;

FIG. 10 and FIG. 11 are diagrams for illustrating a circuitry configuration of an electronic device 100 according to an embodiment of the disclosure; and

FIG. 12 is a flow chart for illustrating a method for manufacturing an electronic device according to an embodiment of the disclosure.

### MODE FOR INVENTION

The purpose of the disclosure is in providing an electronic device that can maintain current balancing and voltage balancing while using a plurality of converters, and a method for manufacturing the same.

Hereinafter, the disclosure will be described in detail with reference to the accompanying drawings.

As terms used in the embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Further, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second,” and the like used in this specification may be used to describe various elements regardless of any order and/or degree of importance. Also, such expressions are used only to distinguish one element from another element, and are not intended to limit the elements.

Also, singular expressions include plural expressions, as long as they do not obviously mean differently in the context. In addition, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, in this specification, the term “user” may refer to a person who uses an electronic device or a device using an electronic device (e.g.: an artificial intelligence electronic device).

Hereinafter, various embodiments of the disclosure will be described in more detail with reference to the accompanying drawings.

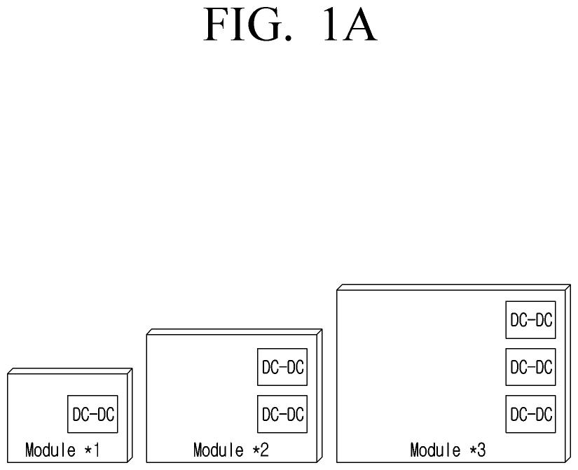

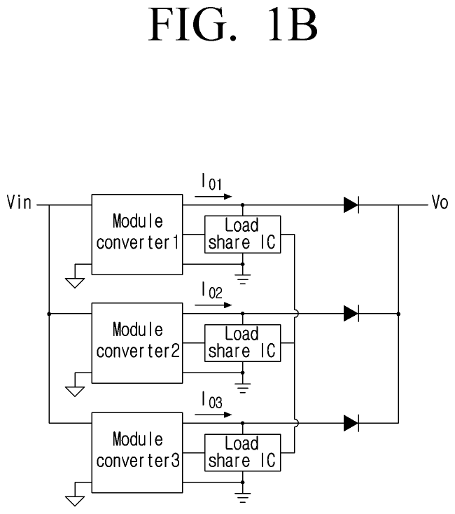

FIG. 1A and FIG. 1B are diagrams for illustrating an example of using a plurality of converters.

LED display devices such as micro LEDs, OLEDs, etc. need power supply for driving LEDs, and as the sizes of LED displays get bigger, the used LEDs increase, and accordingly, driving currents increase. That is, the sizes of necessary driving currents vary according to the sizes of LED displays, and different power converters may be used for each of them. For example, sizes of TVs are diverse from 30 inches in a small scale to 90 inches or bigger in a large scale, and various types of power converters according to various sizes are needed. Also, as power converters cannot be shared, there is a problem that the unit price of each converter increases.

For resolving such a problem, a module type converter was developed. For example, as illustrated in FIG. 1A, in case the size of a TV is small, a relatively small amount of driving currents are needed, and thus one module-type converter is used, and as the size of a TV gets bigger, necessary driving currents increase, and thus the number of module-type converters may be increased in parallel. In this case, as module-type converters in the same form may be used by sharing with respect to various sizes of TVs, the unit price of each module-type converter can be reduced.

However, in the case of connecting module-type converters in parallel, it is necessary to maintain the balance of currents flowing in each converter. As inputs/outputs are connected in parallel, input/output voltages of each converter are the same, but currents that flow may vary according to deviations in element values used in each converter, etc., and in the worst case, currents may flow to only one converter.

For resolving such a problem, as illustrated in FIG. 1B, a load share IC may be included in the output end of each module-type converter, and the current balance may be maintained through the load share IC. The load share IC may designate the module wherein the most output currents are flowing as a master module and designate the remaining modules as slave modules, and heighten the currents flowing in each slave module by heightening the output voltages of the slave modules little by little. Here, if the module wherein the most output currents are flowing is changed, the load share IC may designate the module as the master module, and maintain the current balance through the aforementioned process. However, there is a problem that, as a load share IC needs to be provided for each module, the manufacturing cost increases, and in case an output voltage is high, it is difficult to use a load share IC.

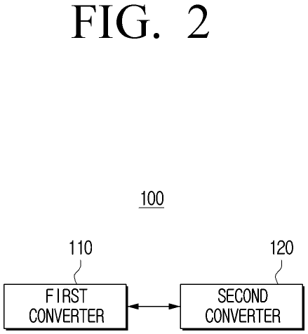

FIG. 2 is a block diagram illustrating a configuration of an electronic device 100 according to an embodiment of the disclosure.

The electronic device 100 is a device that includes at least one converter, and it may be a computer main body, a set top box (STB), an AI speaker, a TV, a desktop PC, a laptop, a smartphone, a tablet PC, smart glasses, and a smart watch, etc. However, the disclosure is not limited thereto, and the electronic device 100 can be any device if it is a device including at least one converter.

As illustrated in FIG. 2, the electronic device 100 may include a first converter 110 and a second converter 120. The first converter 110 and the second converter 120 may be devices that supply power to each circuit component of the electronic device 100. However, the disclosure is not limited thereto, and the first converter 110 and the second converter 120 may be devices that supply power to each circuit component of an external device.

The first converter 110 may include a first transformer and a second transformer of which primary winding is connected in parallel with a primary winding of the first transformer. A primary input end of the second converter 120 may be connected in parallel with the first converter, and the second converter 120 may include a third transformer and a fourth transformer of which primary winding is connected in parallel with a primary winding of the third transformer. Here, a secondary winding included in the first converter may be connected in series with a secondary winding included in the second converter.

For example, a secondary winding of the first transformer may be connected in series with a secondary winding of one of the third transformer or the fourth transformer, and a secondary winding of the second transformer may be connected in series with a secondary winding of the other one of the third transformer or the fourth transformer.

That is, the current balance can be maintained as the secondary sides are connected in series.

The first converter 110 may further include a first switch controlled by a first gate signal, and a second switch controlled by a second gate signal, and the second converter 120 may further include a third switch controlled by the first gate signal, and a fourth switch controlled by the second gate signal.

Here, the primary input ends of the first converter 110 and the second converter 120 are connected in parallel, but the primary windings of the transformers included in the first converter 110 and the primary windings of the transformers included in the second converter 120 are not connected in parallel due to the switches included in each of the first converter 110 and the second converter 120. However, the voltage balance can be maintained as the primary winding of the first transformer and the primary winding of the second transformer included in the first converter 110 are connected in parallel, and the primary winding of the third transformer and the primary winding of the fourth transformer included in the second converter 120 are connected in parallel.

The first converter 110 and the second converter 120 as above may be implemented on a printed circuit board (PCB), or implemented as module types that can be detached from the electronic device 100. In particular, the electronic device 100 may include a socket for adding a converter implemented as a module type.

For example, the electronic device 100 may include a third converter of which primary input end is connected in parallel with the first converter 110 and the second converter 120, and which includes a fifth transformer and a sixth transformer of which primary winding is connected in parallel with a primary winding of the fifth transformer. Here, a secondary winding of the first transformer may be connected in series with a secondary winding of the third transformer, a secondary winding of the second transformer may be connected in series with a secondary winding of the sixth transformer, and a secondary winding of the fourth transformer may be connected in series with a secondary winding of the fifth transformer.

However, the disclosure is not limited thereto, and the first converter 110, the second converter 120, and the third converter may be implemented on a PCB. Alternatively, the electronic device 100 may include four or more converters.

The first converter 110 and the second converter 120 may be implemented based on a center tap rectifier.

For example, the electronic device 100 may further include a first diode of which anode is grounded, a second diode of which anode is grounded, a third diode of which anode is grounded, a fourth diode of which anode is grounded, and an output capacitor of which one end is grounded. Also, a secondary winding of the first transformer may include a secondary first winding of the first transformer of which one end is connected to a cathode of the first diode and a secondary second winding of the first transformer of which one end is connected to a cathode of the second diode, and a secondary winding of the second transformer may include a secondary first winding of the second transformer of which one end is connected to a cathode of the third diode and a secondary second winding of the second transformer of which one end is connected to a cathode of the fourth diode, and a secondary winding of the third transformer may include a secondary first winding of the third transformer of which one end is connected to the other end of the secondary first winding of the first transformer and of which other end is connected to the other end of the output capacitor, and a secondary second winding of the third transformer of which one end is connected to the other end of the secondary second winding of the first transformer and of which other end is connected to the other end of the output capacitor, and a secondary winding of the fourth transformer may include a secondary first winding of the fourth transformer of which one end is connected to the other end of the secondary first winding of the second transformer and of which other end is connected to the other end of the output capacitor, and a secondary second winding of the fourth transformer of which one end is connected to the other end of the secondary second winding of the second transformer and of which other end is connected to the other end of the output capacitor.

Alternatively, the first converter 110 and the second converter 120 may be implemented based on a full bridge rectifier.

For example, the electronic device 100 may further include an output capacitor of which one end is grounded, a first diode of which cathode is connected to the other end of the output capacitor, a second diode of which cathode is connected to an anode of the first diode, and of which anode is grounded, a third diode of which cathode is connected to the other end of the output capacitor, a fourth diode of which cathode is connected to an anode of the third diode, and of which anode is grounded, a fifth diode of which cathode is connected to the other end of the output capacitor, a sixth diode of which cathode is connected to an anode of the fifth diode, and of which anode is grounded, a seventh diode of which cathode is connected to the other end of the output capacitor, and an eighth diode of which cathode is connected to an anode of the seventh diode, and of which anode is grounded. Also, one end of a secondary winding of the first transformer may be connected to the anode of the first diode, one end of a secondary winding of the second transformer may be connected to the anode of the fifth diode, one end of a secondary winding of the third transformer may be connected to the other end of the secondary winding of the first transformer, and the other end may be connected to the anode of the third diode, and one end of a secondary winding of the fourth transformer may be connected to the other end of the secondary winding of the second transformer, and the other end may be connected to the anode of the seventh diode.

Alternatively, the first converter 110 and the second converter 120 may be implemented based on a voltage doubler rectifier.

For example, the electronic device 100 may further include an output capacitor of which one end is grounded, a first diode of which cathode is connected to the other end of the output capacitor, a second diode of which cathode is connected to an anode of the first diode, and of which anode is grounded, a first capacitor of which one end is connected to the other end of the output capacitor, a second capacitor of which one end is connected to the other end of the first capacitor, and of which other end is grounded, a third diode of which cathode is connected to the other end of the output capacitor, a fourth diode of which cathode is connected to an anode of the third diode, and of which anode is grounded, a third capacitor of which one end is connected to the other end of the output capacitor, and a fourth capacitor of which one end is connected to the other end of the third capacitor, and of which other end is grounded. Also, one end of a secondary winding of the first transformer may be connected to the anode of the first diode, one end of a secondary winding of the second transformer may be connected to the anode of the third diode, one end of a secondary winding of the third transformer may be connected to the other end of the secondary winding of the first transformer, and the other end may be connected to the other end of the first capacitor, and one end of a secondary winding of the fourth transformer may be connected to the other end of the secondary winding of the second transformer, and the other end may be connected to the other end of the third capacitor.

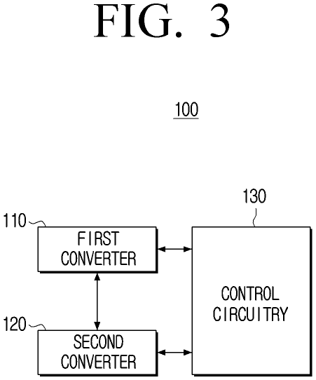

FIG. 3 is a block diagram illustrating a detailed configuration of the electronic device 100 according to an embodiment of the disclosure.

FIG. 3 is a block diagram illustrating a detailed configuration of the electronic device 100 according to an embodiment of the disclosure. The electronic device 100 may include the first converter 110 and the second converter 120. Also, according to FIG. 3, the electronic device 100 may further include communication circuitry 130. Among the components illustrated in FIG. 3, regarding parts that overlap with the components illustrated in FIG. 2, detailed explanation will be omitted.

If the second converter 120 is not detected, the control circuitry 130 may provide an output voltage from one end of a secondary winding of the first transformer and one end of a secondary winding of the second transformer, and if the second converter 120 is detected, the control circuitry 130 may provide an output voltage from one end of a secondary winding of the third transformer and one end of a secondary winding of the fourth transformer.

For example, if the second converter 120 is connected, one end of the secondary winding of the first transformer and a node wherein an output voltage is provided are connected to the secondary winding of one of the third transformer or the fourth transformer, and one end of the secondary winding of the second transformer and a node wherein an output voltage is provided are connected to the secondary winding of the other one of the third transformer or the fourth transformer, and accordingly, current balancing can be maintained. In contrast, if the second converter 120 is not connected, one end of the secondary winding of the first transformer and the node wherein an output voltage is provided are opened, and one end of the secondary winding of the second transformer and the node wherein an output voltage is provided are opened, and accordingly, currents may not flow. In this case, the control circuitry 130 may short-circuit the opened sections such that power can be supplied only with the first converter 110, even though the second converter 120 is not connected. Detailed explanation in this regard will be described with reference to the drawings that will be described below.

As described above, the electronic device supplies power by using converters implemented as module types, and thus implementation is possible in a variable manner, and at the same time, the manufacturing cost can be saved. Also, the primary sides of the plurality of converters included in the electronic device are connected in parallel, and their secondary sides are connected in series, and thus voltage balancing and current balancing can be maintained without including additional hardware.

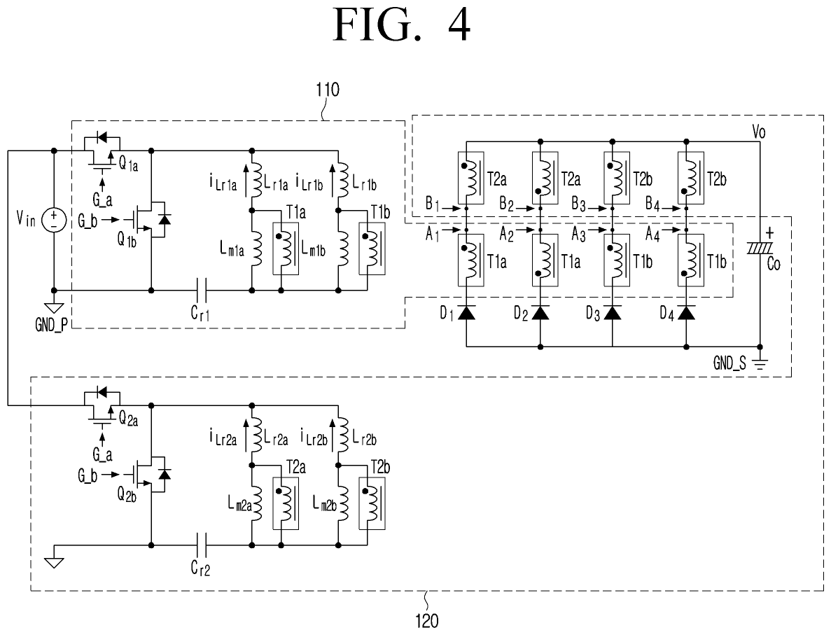

Hereinafter, operations of the electronic device 100 will be described in more detail through FIG. 4 to FIG. 11. In FIG. 4 to FIG. 11, individual embodiments will be explained for the convenience of explanation. However, the individual embodiments in FIG. 4 to FIG. 11 can be implemented in any combined states.

FIG. 4 is a diagram for illustrating a circuitry configuration of the electronic device 100 according to an embodiment of the disclosure. In FIG. 4, it was assumed that the first converter 110 and the second converter 120 are implemented based on a center tap rectifier, and each converter is an LLC resonant type converter.

The first converter 110 may include a first transformer and a second transformer, and a primary winding T1a of the first transformer and a primary winding T1b of the second transformer may be connected in parallel. The first converter 110 may further include a first switch Q1a controlled by a first gate signal G_a, and a second switch Q1b controlled by a second gate signal G_b.

The second converter 120 may include a third transformer and a fourth transformer, and a primary winding T2a of the third transformer and a primary winding T2b of the fourth transformer may be connected in parallel. The second converter 120 may further include a third switch Q2a controlled by a first gate signal G_a, and a fourth switch Q2b controlled by a second gate signal G_b.

As the primary winding T1a of the first transformer and the primary winding T1b of the second transformer are connected in parallel, and the primary winding T2a of the third transformer and the primary winding T2b of the fourth transformer are connected in parallel, voltage balancing between the transformers can be maintained.

The first converter 110 and the second converter 120 may respectively receive an input voltage through a drain of the first switch and a drain of the third switch. That is, the primary input ends of the first converter 110 and the second converter 120 may be connected in parallel. Also, as each of the first converter 110 and the second converter 120 includes a switch, burden on each switch does not increase.

The secondary winding included in the first converter 110 may be connected in series with the secondary winding included in the second converter 120. For example, a secondary first winding T1a of the first transformer and a secondary second winding T1a of the first transformer may respectively be connected in series with a secondary first winding T2a of the third transformer and a secondary second winding T2a of the third transformer, and a secondary first winding T1b of the second transformer and a secondary second winding T1b of the second transformer may respectively be connected in series with a secondary first winding T2b of the fourth transformer and a secondary second winding T2b of the fourth transformer. Accordingly, current balancing between the transformers can be maintained. In particular, as the transformers of the first converter 110 and the transformers of the second converter 120 are connected in series on the secondary sides, current balancing between the first converter 110 and the second converter 120 can be maintained.

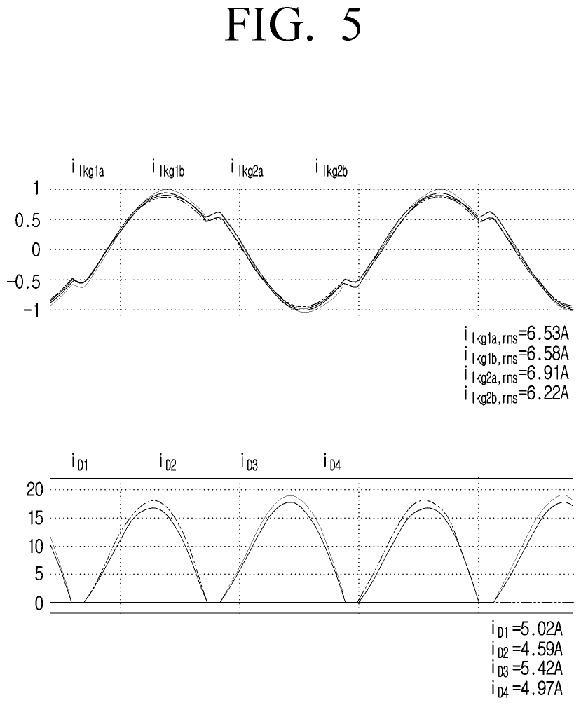

FIG. 5 is a diagram for illustrating a simulation result according to an embodiment of the disclosure. In FIG. 5, it was assumed that the values of the capacitances and the inductances have a deviation of 10% between the first converter 110 and the second converter 120.

As illustrated in the upper part of FIG. 5, balance of currents flowing on the primary sides of each transformer was maintained without a big difference.

As illustrated in the lower part of FIG. 5, balance of currents flowing in each diode on the secondary sides was maintained without a phase difference.

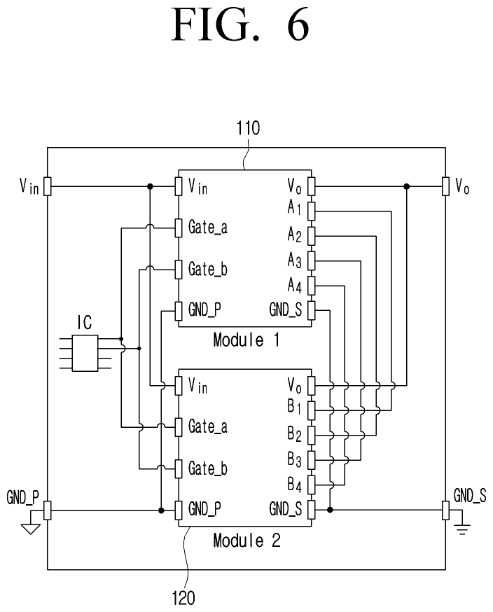

FIG. 6 is a diagram for illustrating a case wherein a plurality of converters are implemented on a PCB according to an embodiment of the disclosure.

As illustrated in FIG. 6, the first converter 110 and the second converter 120 may be implemented on one PCB. In the case of the primary sides, an input voltage may be applied to a Vin terminal of the first converter 110 and a Vin terminal of the second terminal 120 through an external Vin terminal. Grounds may be connected to a GND_P terminal of the first converter 110 and a GND_P terminal of the second converter 120 through an external ground terminal GND_P. Gate signals on the primary sides may be output at a control IC, and may be applied to a Gate_a terminal and a Gate_b terminal of the first converter 110 and a Gate_a terminal and a Gate_b terminal of the second converter 120.

In the case of the secondary sides, output voltages VO, grounds GND_S, and connection points A1-B1, A2-B2, A3-B3, A4-B4 of the first converter 110 and the second converter 120 may be connected, and VO and GND_S may respectively be connected to an external terminal.

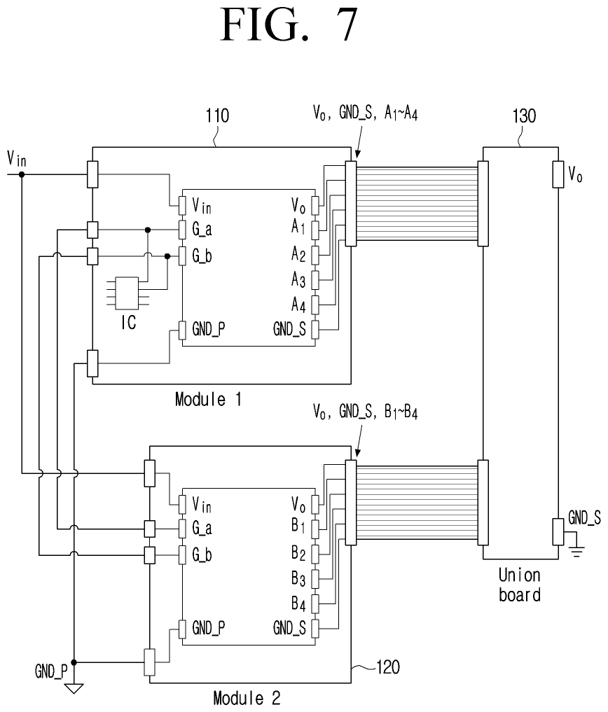

FIG. 7 is a diagram for illustrating a case wherein each of a plurality of converters is implemented as a module type according to an embodiment of the disclosure.

As illustrated in FIG. 7, the first converter 110 and the second converter 120 may be implemented as module types that can be detached from the electronic device 100. Here, the first converter 110 and the second converter 120 may have the same structure, and have the same capacity. However, there may be errors in manufacturing.

In the case of the primary sides, external input voltages may be connected to the Vin terminal of the first converter 110 and the Vin terminal of the second terminal 120. Grounds may be connected to the GND_P terminal of the first converter 110 and the GND_P terminal of the second converter 120. Gate signals on the primary sides may be output at the control IC, and may be applied to a G_a terminal and a G_b terminal of the first converter 110 and a G_a terminal and a G_b terminal of the second converter 120.

However, the disclosure is not limited thereto, and the first converter 110 may be implemented in a form of including a control IC.

In the case of the secondary sides, output voltages VO, grounds GND_S, and connection points of the first converter 110 and the second converter 120 may be connected to control circuitry (a union board 130), and the VO, the GND_S, and the connection points may be connected inside the control circuitry 130.

Here, if the second converter 120 is not detected, the control circuitry 130 may provide an output voltage from one end of the secondary winding of the first transformer and one end of the secondary winding of the second transformer, and if the second converter 120 is detected, the control circuitry 130 may provide an output voltage from one end of the secondary winding of the third transformer and one end of the secondary winding of the fourth transformer.

Taking FIG. 4 as an example, the control circuitry 130 may include a first transistor connected in parallel to the secondary first winding T2a of the third transformer, a second transistor connected in parallel to the secondary second winding T2a of the third transformer, a third transistor connected in parallel to the secondary first winding T2b of the fourth transformer, and a fourth transistor connected in parallel to the secondary second winding T2b of the fourth transformer. Also, if the second converter 120 is not detected, the control circuitry 130 may turn on the first transistor to the fourth transistor, and if the second converter 120 is detected, the control circuitry 130 may turn off the first transistor to the fourth transistor. The control circuitry 130 may detect whether the second converter 120 is connected based on whether currents flow in at least one of the secondary first winding T1a of the first transformer, the secondary second winding T1a of the first transformer, the secondary first winding T1b of the second transformer, or the secondary second winding T1b of the second transformer.

In the above, an example of the control circuitry 130 was explained for the convenience of explanation, but the control circuitry 130 may be implemented in any diverse forms of circuitry.

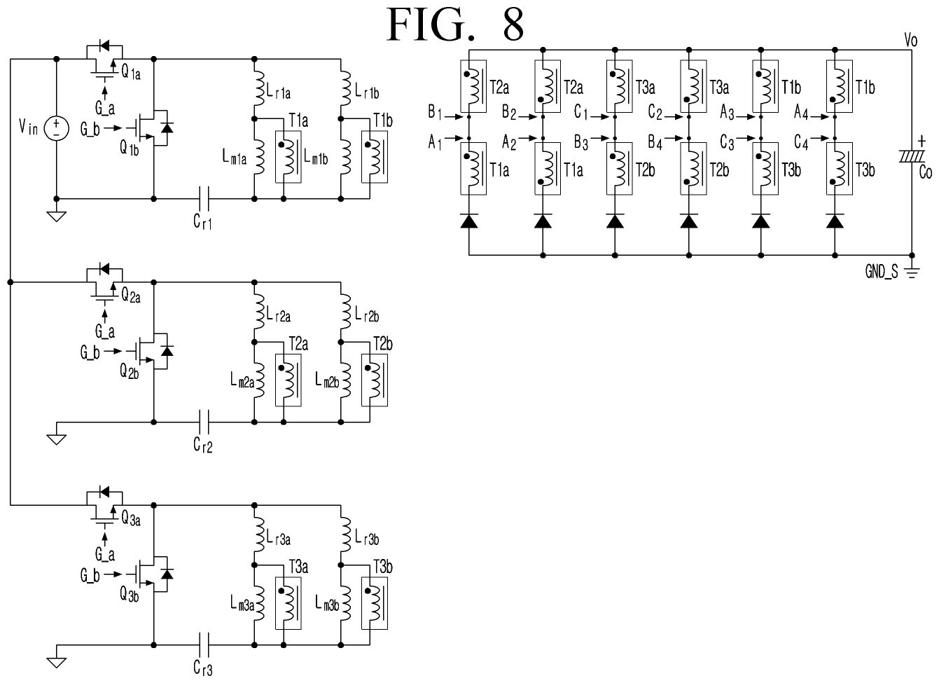

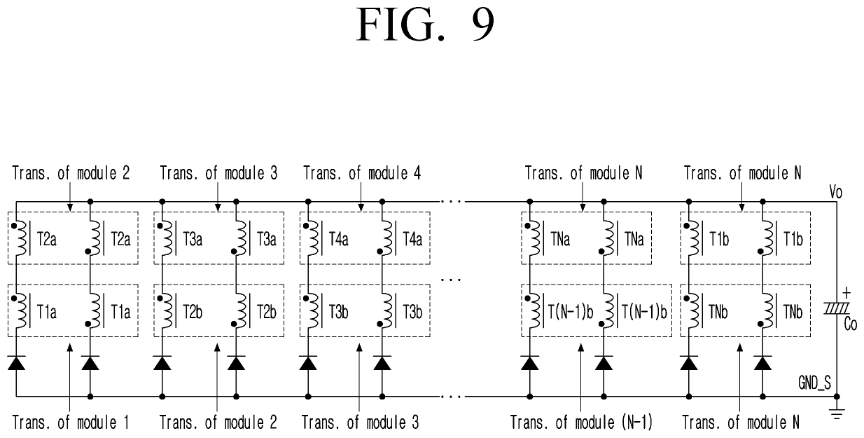

FIG. 8 and FIG. 9 are diagrams for illustrating a case wherein a converter is added to the electronic device 100 according to an embodiment of the disclosure.

As illustrated in FIG. 8, the electronic device 100 may include not only the first converter 110 and the second converter 120, but also further include a third converter of which primary input end is connected in parallel with the first converter 110 and the second converter 120, and which includes a fifth transformer and a sixth transformer of which primary winding is connected in parallel with a primary winding of the fifth transformer. Here, the secondary winding of the first transformer may be connected in series with the secondary winding of the third transformer, the secondary winding of the second transformer may be connected in series with the secondary winding of the sixth transformer, and the secondary winding of the fourth transformer may be connected in series with the secondary winding of the fifth transformer.

In this case, the electronic device 100 may also be implemented by a method as in FIG. 6 or FIG. 7.

In FIG. 8, a case wherein three converters are connected in parallel was explained. However, the disclosure is not limited thereto, and as illustrated in FIG. 9, the electronic device 100 may include N converters connected in parallel.

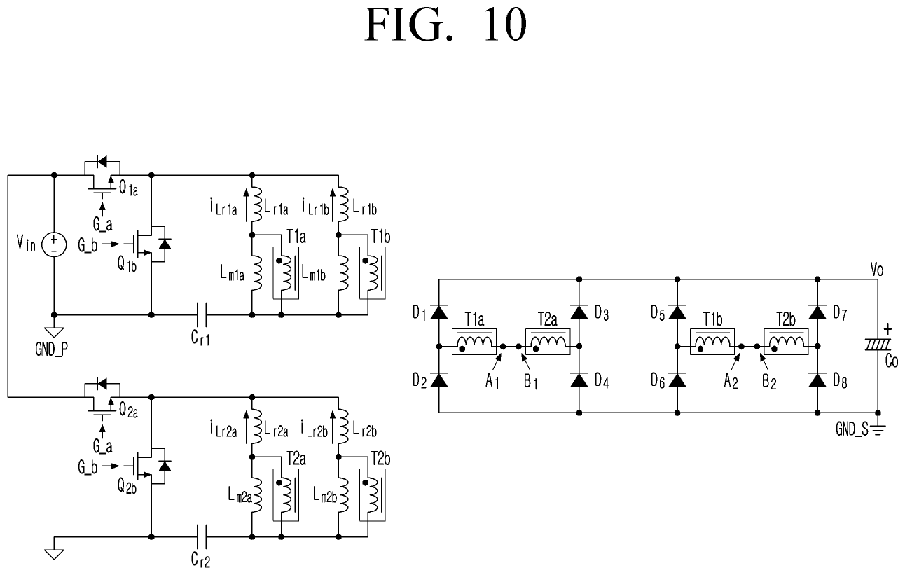

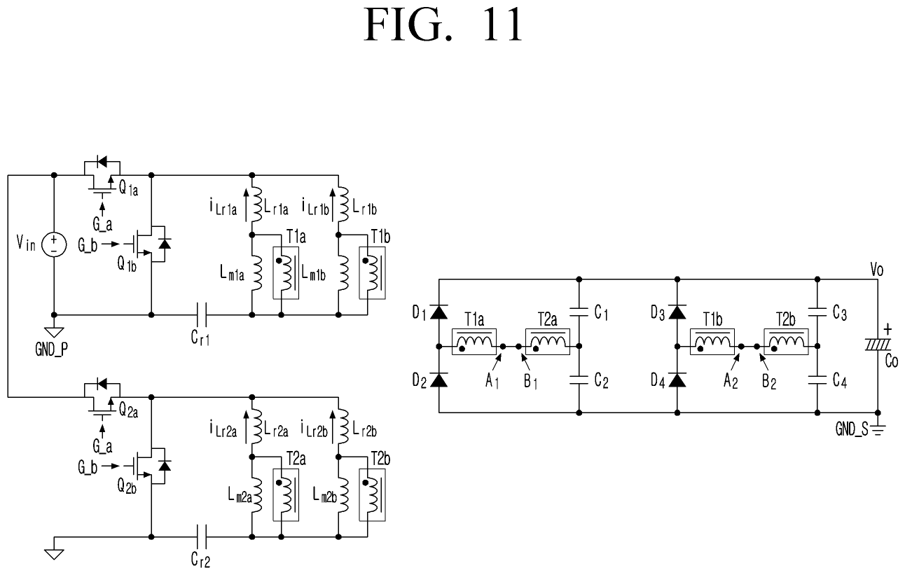

FIG. 10 and FIG. 11 are diagrams for illustrating a circuitry configuration of the electronic device 100 according to an embodiment of the disclosure.

FIG. 10 illustrates a case wherein the first converter 110 and the second converter 120 are implemented based on a full bridge rectifier, and each converter is an LLC resonant type converter. In FIG. 10, the primary sides may be identical to the primary sides in FIG. 4, and on the secondary sides, the number of the windings of the transformers is fewer than in FIG. 4, and thus there may be two connection points.

FIG. 11 illustrates a case wherein the first converter 110 and the second converter 120 are implemented based on a voltage doubler rectifier, and each converter is an LLC resonant type converter. In FIG. 11, the primary sides may be identical to the primary sides in FIG. 4, and on the secondary sides, the number of the windings of the transformers is fewer than in FIG. 4, and thus there may be two connection points.

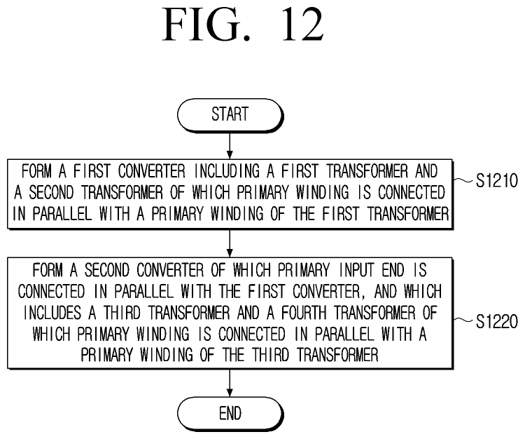

FIG. 12 is a flow chart for illustrating a method for manufacturing an electronic device according to an embodiment of the disclosure.

First, a first converter including a first transformer and a second transformer of which primary winding is connected in parallel with a primary winding of the first transformer is formed in the step S1210. Then, a second converter of which primary input end is connected in parallel with the first converter, and which includes a third transformer and a fourth transformer of which primary winding is connected in parallel with a primary winding of the third transformer is formed in operation S1220. Here, a secondary winding included in the first converter may be connected in series with a secondary winding included in the second converter.

Also, a secondary winding of the first transformer may be connected in series with a secondary winding of one of the third transformer or the fourth transformer, and a secondary winding of the second transformer may be connected in series with a secondary winding of the other one of the third transformer or the fourth transformer.

Meanwhile, the step S1210 of forming the first converter may further include the steps of forming a first switch controlled by a first gate signal, and forming a second switch controlled by a second gate signal. Also, the step S1220 of forming the second converter may further include the steps of forming a third switch controlled by the first gate signal, and forming a fourth switch controlled by the second gate signal.

In addition, the manufacturing method may further include the step of forming control circuitry configured to, based on the second converter not being detected, provide an output voltage from one end of a secondary winding of the first transformer and one end of a secondary winding of the second transformer, and based on the second converter being detected, provide an output voltage from one end of a secondary winding of the third transformer and one end of a secondary winding of the fourth transformer.

Also, the manufacturing method may further include the step of forming a third converter of which primary input end is connected in parallel with the first converter and the second converter, and which includes a fifth transformer and a sixth transformer of which primary winding is connected in parallel with a primary winding of the fifth transformer, wherein a secondary winding of the first transformer may be connected in series with a secondary winding of the third transformer, a secondary winding of the second transformer may be connected in series with a secondary winding of the sixth transformer, and a secondary winding of the fourth transformer may be connected in series with a secondary winding of the fifth transformer.

Meanwhile, the manufacturing method may further include the steps of forming a first diode of which anode is grounded, forming a second diode of which anode is grounded, forming a third diode of which anode is grounded, forming a fourth diode of which anode is grounded, and forming an output capacitor of which one end is grounded, wherein a secondary winding of the first transformer may include a secondary first winding of the first transformer of which one end is connected to a cathode of the first diode and a secondary second winding of the first transformer of which one end is connected to a cathode of the second diode, and a secondary winding of the second transformer may include a secondary first winding of the second transformer of which one end is connected to a cathode of the third diode and a secondary second winding of the second transformer of which one end is connected to a cathode of the fourth diode, and a secondary winding of the third transformer may include a secondary first winding of the third transformer of which one end is connected to the other end of the secondary first winding of the first transformer and of which other end is connected to the other end of the output capacitor, and a secondary second winding of the third transformer of which one end is connected to the other end of the secondary second winding of the first transformer and of which other end is connected to the other end of the output capacitor, and a secondary winding of the fourth transformer may include a secondary first winding of the fourth transformer of which one end is connected to the other end of the secondary first winding of the second transformer and of which other end is connected to the other end of the output capacitor, and a secondary second winding of the fourth transformer of which one end is connected to the other end of the secondary second winding of the second transformer and of which other end is connected to the other end of the output capacitor.

Alternatively, the manufacturing method may further include the steps of forming an output capacitor of which one end is grounded, forming a first diode of which cathode is connected to the other end of the output capacitor, forming a second diode of which cathode is connected to an anode of the first diode, and of which anode is grounded, forming a third diode of which cathode is connected to the other end of the output capacitor, forming a fourth diode of which cathode is connected to an anode of the third diode, and of which anode is grounded, forming a fifth diode of which cathode is connected to the other end of the output capacitor, forming a sixth diode of which cathode is connected to an anode of the fifth diode, and of which anode is grounded, forming a seventh diode of which cathode is connected to the other end of the output capacitor, and forming an eighth diode of which cathode is connected to an anode of the seventh diode, and of which anode is grounded, wherein one end of a secondary winding of the first transformer may be connected to the anode of the first diode, one end of a secondary winding of the second transformer may be connected to the anode of the fifth diode, one end of a secondary winding of the third transformer may be connected to the other end of the secondary winding of the first transformer, and the other end may be connected to the anode of the third diode, and one end of a secondary winding of the fourth transformer may be connected to the other end of the secondary winding of the second transformer, and the other end may be connected to the anode of the seventh diode.

Alternatively, the manufacturing method may further include the steps of forming an output capacitor of which one end is grounded, forming a first diode of which cathode is connected to the other end of the output capacitor, forming a second diode of which cathode is connected to an anode of the first diode, and of which anode is grounded, forming a first capacitor of which one end is connected to the other end of the output capacitor, forming a second capacitor of which one end is connected to the other end of the first capacitor, and of which other end is grounded, forming a third diode of which cathode is connected to the other end of the output capacitor, forming a fourth diode of which cathode is connected to an anode of the third diode, and of which anode is grounded, forming a third capacitor of which one end is connected to the other end of the output capacitor, and forming a fourth capacitor of which one end is connected to the other end of the third capacitor, and of which other end is grounded, wherein one end of a secondary winding of the first transformer may be connected to the anode of the first diode, one end of a secondary winding of the second transformer may be connected to the anode of the third diode, one end of a secondary winding of the third transformer may be connected to the other end of the secondary winding of the first transformer, and the other end may be connected to the other end of the first capacitor, and one end of a secondary winding of the fourth transformer may be connected to the other end of the secondary winding of the second transformer, and the other end may be connected to the other end of the third capacitor.

Meanwhile, the first converter and the second converter may be implemented on a printed circuit board (PCB).

Alternatively, the first converter and the second converter may be implemented as module types that can be detached from the electronic device.

Here, the first converter and the second converter may have the same structure, and have the same capacity.

According to the various embodiments of the disclosure as above, the electronic device supplies power by using converters implemented as module types, and thus implementation is possible in a variable manner, and at the same time, the manufacturing cost can be saved.

Also, the primary sides of the plurality of converters included in the electronic device are connected in parallel, and their secondary sides are connected in series, and thus voltage balancing and current balancing can be maintained without including additional hardware.

Further, as the electronic device can be extended to a structure wherein the plurality of converters are connected in parallel, the electronic device can be designed to cover power capacities in various ranges, and as a load share IC is not used even if a converter is added, current deviations due to sensing noises are not generated.

Also, in the past, a load share IC could not be used in case an output voltage is high because of a differential amplifier for current sensing, but according to the disclosure, current balancing can be maintained regardless of the size of an output voltage.

Meanwhile, according to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the embodiments disclosed herein (e.g.: an electronic device A). In case an instruction is executed by a processor, the processor may perform a function corresponding to the instruction by itself, or by using other components under its control. An instruction may include a code that is generated or executed by a compiler or an interpreter. A storage medium readable by machines may be provided in the form of a non-transitory storage medium. Here, the term ‘non-transitory’ only means that a storage medium does not include signals, and is tangible, and the term does not distinguish a case wherein data is stored in the storage medium semi-permanently and a case wherein data is stored temporarily.

Also, according to an embodiment of the disclosure, the method according to the aforementioned various embodiments may be provided while being included in a computer program product. A computer program product refers to a product, and it can be traded between a seller and a buyer. A computer program product can be distributed on-line in the form of a storage medium that is readable by machines (e.g.: compact disc read only memory (CD-ROM)), or through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

Further, according to an embodiment of the disclosure, the aforementioned various embodiments may be implemented in a recording medium that can be read by a computer or a device similar to a computer, by using software, hardware, or a combination thereof. In some cases, the embodiments described in this specification may be implemented as a processor itself. According to implementation by software, the embodiments such as processes and functions described in this specification may be implemented as separate software modules. Each of the software modules can perform one or more functions and operations described in this specification.

Meanwhile, computer instructions for performing processing operations of machines according to the aforementioned various embodiments may be stored in a non-transitory computer-readable medium. Computer instructions stored in such a non-transitory computer-readable medium make the processing operations at machines according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and memory. As specific examples of a non-transitory computer-readable medium, there may be a CD, a DVD, a hard disc, a blue-ray disc, a USB, a memory card, ROM and the like.

Further, each of the components according to the aforementioned various embodiments (e.g.: a module or a program) may consist of a singular object or a plurality of objects. Also, among the aforementioned corresponding sub components, some sub components may be omitted, or other sub components may be further included in the various embodiments. Alternatively or additionally, some components (e.g.: a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

1. An electronic device comprising:
a first converter including a first transformer and a second transformer of which a primary winding is connected in parallel with a primary winding of the first transformer; and
a second converter of which a primary input end is connected in parallel with the first converter, and which includes a third transformer and a fourth transformer of which a primary winding is connected in parallel with a primary winding of the third transformer,
wherein a secondary winding included in the first converter is connected in series with a secondary winding included in the second converter.

2. The electronic device of claim 1, wherein
a secondary winding of the first transformer is connected in series with a secondary winding of one of the third transformer or the fourth transformer, and
a secondary winding of the second transformer is connected in series with a secondary winding of the other one of the third transformer or the fourth transformer.

3. The electronic device of claim 1, wherein
the first converter further includes:
a first switch controlled by a first gate signal, and
a second switch controlled by a second gate signal, and
the second converter further includes:
a third switch controlled by the first gate signal, and
a fourth switch controlled by the second gate signal.

4. The electronic device of claim 1, further comprising:
control circuitry configured to:
based on the second converter not being detected, provide an output voltage from one end of a secondary winding of the first transformer and one end of a secondary winding of the second transformer, and
based on the second converter being detected, provide an output voltage from one end of a secondary winding of the third transformer and one end of a secondary winding of the fourth transformer.

5. The electronic device of claim 1, further comprising:
a third converter of which a primary input end is connected in parallel with the first converter and the second converter, and which includes a fifth transformer and a sixth transformer of which a primary winding is connected in parallel with a primary winding of the fifth transformer,
wherein
a secondary winding of the first transformer is connected in series with a secondary winding of the third transformer,
a secondary winding of the second transformer is connected in series with a secondary winding of the sixth transformer, and
a secondary winding of the fourth transformer is connected in series with a secondary winding of the fifth transformer.

6. The electronic device of claim 1, further comprising:
a first diode of which an anode is grounded;
a second diode of which an anode is grounded;
a third diode of which an anode is grounded;
a fourth diode of which an anode is grounded; and
an output capacitor of which one end is grounded,
wherein
a secondary winding of the first transformer includes a secondary first winding of the first transformer of which one end is connected to a cathode of the first diode and a secondary second winding of the first transformer of which one end is connected to a cathode of the second diode,
a secondary winding of the second transformer includes a secondary first winding of the second transformer of which one end is connected to a cathode of the third diode and a secondary second winding of the second transformer of which one end is connected to a cathode of the fourth diode,
a secondary winding of the third transformer includes a secondary first winding of the third transformer of which one end is connected to the other end of the secondary first winding of the first transformer and of which other end is connected to the other end of the output capacitor, and a secondary second winding of the third transformer of which one end is connected to the other end of the secondary second winding of the first transformer and of which other end is connected to the other end of the output capacitor, and
a secondary winding of the fourth transformer includes a secondary first winding of the fourth transformer of which one end is connected to the other end of the secondary first winding of the second transformer and of which other end is connected to the other end of the output capacitor, and a secondary second winding of the fourth transformer of which one end is connected to the other end of the secondary second winding of the second transformer and of which other end is connected to the other end of the output capacitor.

7. The electronic device of claim 1, further comprising:
an output capacitor of which one end is grounded;
a first diode of which a cathode is connected to the other end of the output capacitor;
a second diode of which a cathode is connected to an anode of the first diode, and of which an anode is grounded;
a third diode of which a cathode is connected to the other end of the output capacitor;
a fourth diode of which a cathode is connected to an anode of the third diode, and of which an anode is grounded;
a fifth diode of which a cathode is connected to the other end of the output capacitor;
a sixth diode of which a cathode is connected to an anode of the fifth diode, and of which an anode is grounded;
a seventh diode of which a cathode is connected to the other end of the output capacitor; and
an eighth diode of which a cathode is connected to an anode of the seventh diode, and of which an anode is grounded,
wherein
one end of a secondary winding of the first transformer is connected to the anode of the first diode,
one end of a secondary winding of the second transformer is connected to the anode of the fifth diode,
one end of a secondary winding of the third transformer is connected to the other end of the secondary winding of the first transformer, and the other end is connected to the anode of the third diode, and
one end of a secondary winding of the fourth transformer is connected to the other end of the secondary winding of the second transformer, and the other end is connected to the anode of the seventh diode.

8. The electronic device of claim 1, further comprising:
an output capacitor of which one end is grounded;
a first diode of which a cathode is connected to the other end of the output capacitor;
a second diode of which a cathode is connected to an anode of the first diode, and of which an anode is grounded;
a first capacitor of which one end is connected to the other end of the output capacitor;
a second capacitor of which one end is connected to the other end of the first capacitor, and of which other end is grounded;
a third diode of which a cathode is connected to the other end of the output capacitor;
a fourth diode of which a cathode is connected to an anode of the third diode, and of which an anode is grounded;
a third capacitor of which one end is connected to the other end of the output capacitor; and
a fourth capacitor of which one end is connected to the other end of the third capacitor, and of which other end is grounded;
wherein
one end of a secondary winding of the first transformer is connected to the anode of the first diode,
one end of a secondary winding of the second transformer is connected to the anode of the third diode,
one end of a secondary winding of the third transformer is connected to the other end of the secondary winding of the first transformer, and the other end is connected to the other end of the first capacitor, and
one end of a secondary winding of the fourth transformer is connected to the other end of the secondary winding of the second transformer, and the other end is connected to the other end of the third capacitor.

9. The electronic device of claim 1, wherein the first converter and the second converter are implemented on a printed circuit board (PCB).

10. The electronic device of claim 1, wherein the first converter and the second converter are implemented as module types that are detachable from the electronic device.

11. The electronic device of claim 10, wherein the first converter and the second converter have a same structure, and have a same capacity.

12. A method for manufacturing an electronic device, the method comprising:
forming a first converter including a first transformer and a second transformer of which a primary winding is connected in parallel with a primary winding of the first transformer; and
forming a second converter of which a primary input end is connected in parallel with the first converter, and which includes a third transformer and a fourth transformer of which a primary winding is connected in parallel with a primary winding of the third transformer,
wherein a secondary winding included in the first converter is connected in series with a secondary winding included in the second converter.

13. The method of claim 12,
wherein a secondary winding of the first transformer is connected in series with a secondary winding of one of the third transformer or the fourth transformer, and
a secondary winding of the second transformer is connected in series with a secondary winding of the other one of the third transformer or the fourth transformer.

14. The method of claim 12, wherein
the forming the first converter further includes:
forming a first switch controlled by a first gate signal, and
forming a second switch controlled by a second gate signal, and
the forming the second converter further includes:
forming a third switch controlled by the first gate signal; and
forming a fourth switch controlled by the second gate signal.

15. The method of claim 12, further comprising:
forming communication circuitry configured to, based on the second converter not being detected, provide an output voltage from one end of a secondary winding of the first transformer and one end of a secondary winding of the second transformer, and based on the second converter being detected, provide an output voltage from one end of a secondary winding of the third transformer and one end of a secondary winding of the fourth transformer.
